(19) United States
(12) Patent Application Publication
(10) Pub. No.: US 2008/0232137 A1
(43) Pub. Date: Sep. 25, 2008

(54) Light guide plate, surface light source device and image display

(75) Inventors: Yasuyuki Fukuda, Saitama-shi (JP); Fuminori Hiraishi, Tokyo (JP)

Correspondence Address: STAAS & HALSEY LLP, SUITE 700, 1201 NEW YORK AVENUE, N.W., WASHINGTON, DC, 20005, US

(73) Assignee: ENPLAS CORPORATION, Saitama (JP)

(21) Appl. No.: 12/000,674

(22) Filed: Dec. 14, 2007

(30) Foreign Application Priority Data
Dec. 15, 2006 (JP) 337759/2006

(51) Int. Cl. F21V 7/00; F21V 7/04

(52) U.S. Cl. 362/620; 362/341; 362/310

(57) ABSTRACT

A light guide plate has an incidence face provided by a side end face, emission face and back face. The incidence face has first and second end edges meeting the emission face and the back face respectively. First range N1 in the emission face is set as to correspond to a reflecting-cover which returns at least a part of light emitted from first range N1 into the light guide plate. The reflecting-cover is disposed along the first end edge, covering a part of the emission face. Most of the returned light is emitted from second range N2, becoming illumination light. First range N1 has emission function weaker than that of second range N2, thereby avoiding the emission from showing abnormal emission in the vicinity of the first end edge. The reflecting-cover may be provided by an end edge portion of a lamp reflector for a primary light source.

### BACKGROUND

1. Field of Invention

The present invention relates to a so-called side-light-type light guide plate which is supplied with light through a side end face and emits light from an emission face, a surface light source device employing the light guide plate and an image display employing the surface light source device for illumination. The present invention is applied to, for example, image displaying arts in portable phones, portable terminal devices, electronic dictionaries, various electric devices or personal computers.

2. Related Arts

A known typical image display is a liquid crystal display (LCD). A liquid crystal display is composed of, for example, a transmission-type LED-panel and a surface light source device for illuminating the LCD-panel. A broadly known and used surface light source device is a so-called side-light-type surface light source device. A side-light-type surface light source device comprises a light guide plate which is supplied with primary light sideway and has an incidence side face in the vicinity of which a primary light source is disposed. Currently used primary light sources are rod-like plight sources such as fluorescent lamp 7s or point-like light sources LEDs.

FIGS. 9 and 10 illustrate an outlined structure of surface light source device 114 in accordance with a prior art ant liquid crystal display 101 including surface light source device 114, such structure being disclosed in Document 1 noted below.

Referring to FIGS. 9 and 10, surface light source device 114 comprises light guide plate 102 and fluorescent lamp (primary light source) 110 disposed along incidence face 103 of light guide plate 102. Light from fluorescent lamp 110 enters into, light guide plate 102 through incidence face 103, becoming inner propagation light. Inner propagation light is emitted from emission face at least one 104 gradually on the way of travelling toward distal end face (a side face opposite to incidence face 103) 122. Proceeding directions of the emitted light are modified by prism sheet 10 as a light control member as to be directed to a generally frontal direction, and member-to-be-illuminated (such as LCD-panel 106) is supplied with the light. A great number of prismatic projections 117 performing light gathering function are formed on back face ( )a major face opposite to emission face 104) 107. On the other hand, a great number of prismatic projections 116 performing emission promotion function are formed on emission face 104.

These functions cause the whole area of emission face 104 to emit highly bright light with directivity.

Further, with surface light source device 114, lamp reflector 111 is disposed as to surround fluorescent lamp 110 and upper end portion 112 of lamp reflector 111 engages with emission face 104. As a result, upper end portion 112 of lamp reflector 111 covers a part of emission face 104 (vicinity of incidence face 103).

On the other hand, lower end portion 1113 of lamp reflector 111 engages with a back face (a lower side face in FIG. 10) of reflecting sheet 108 disposed along back face 107. It is to be noted that prismatic projections 116 performing emission promotion are formed also in a band-like area covered by upper end portion 1112 of lamp reflector 111 and accordingly emission from the same area occurs more easily as compared with as case where no prismatic projections 116 are formed.

On the other hand, in many cases, upper end portion 112 of lamp reflector 1111 has a light reflective inner surface (a surface opposite to emission face 104),) In such cases, a greater part of the light emitted from the above area is reflected by upper end portion 112 and is returned into light guide plate 102. Some of such returning light is emitted from emission face 104 just after being inner/reflected by back face 107. Further, another part of the returning light is emitted from emission face 104 after undergoing a small number of inner-reflections at back face 107 and emission face 104.

Emission from emission face 104 in such ways occurs at positions not far from incidence face 103, bringing ]abnormal emission (so-called reflective appearance).

FIGS. 8a and 9b illustrate such abnormal emission, FIG. 8b showing a state where fluorescent lamp 7110 and lamp reflector 111 is mounted to light guide plate 102 and

FIG. 8a showing a cross section view along line A3-A3 in FIG. 8b.

Now provided as an example is the following dimensions.
Length of each long side of light guide plate 102; 250 mm
Thickness of light guide plate 102; 2.0 mm (the thickest portion) to 0.7 mm (the thinnest portion)
Position of abnormal emission emerging area (distance from incidence face 103); 2.0 mm (thickness at the thickest end)×2.5=55 mM under such as condition, zone in which the above abnormal emission is apt to appear (bright zone) is a belt-like zone extending in parallel with incidence face 103, being located at about at 5.0 mm. Width (and area) of the area (bright zone) R is generally the same as that of range NO.

Needless to say, such abnormal emission reduces quality of illumination or displaying. A possible way of avoiding this is to roughen emission face 104 overall for making emission from emission face 104 diffused light. Although this way makes belt-like bright zone R inconspicuous, emission directivity is disturbed, resulting in a reduced illumination light supply to liquid crystal display 2 panel 6.

Alternatively, light shadowing ability (light absorption ability) may be given to an inner surface (surface opposite to emission face 104) of upper end edge portion 112 of lamp reflector 111 to restrain abnormal emission.

This method brings, however, a result such that emission FROM AREA NO of emission face 104 can not be utilized effectively for illumination. This reduces the total light utilization efficiency an brightness of the total illumination light.

The above-described problem arises in a similar way when A point-like light source such as LED is employed under a condition such that substrate of the point-like light source covers a part of emission face (a part near to an incidence face 3), too.

After all, such problems arise in cases where (1) maintaining a high directivity and (2) emission promotion fun causing light introduced into a light guide plate to be emitted from an emission face is demanded, due to that a part of the emission face (vicinity of incidence face) is covered by an end edge of a lamp reflector, substrate or the like.

It is noted that the term reflecting-cover used in the instant specification means an object (a member or a part of the member, for example, an end edge portion of a lamp reflector,) which has a reflective inner surface and is disposed as to cover a part (a belt-like zone along an edge at which an emission face meets an incidence face) of the emission face, like end edge portion of lamp reflector or substrate.
Document 1; International Publication 2004/079258 pamphlet

### OBJECT AND SUMMARY OF INVENTION

The present invention solves the above-described problems of prior arts. An object of the present invention is to improve a light guide plate used under arrangement of a reflecting-cover so that abnormal emission as mentioned above is restrained without reducing light utilizing efficiency and emission directivity. Another object of the present invention is to provide surface light source device which is able to output bright and uniform illumination light by using such a improved light guide plate. Still another object of the present invention is to provide an image display capable of providing high-quality image display by employing the surface light source device.

In the first place, the present invention is applied to as light guide plate comprising an emission face provided by a major face, a back face provided by another major face located oppositely, an incidence face provided by a side end face, said incidence face meeting said emission face at a first end edge of said incidence face and meeting said back face at a second end edge of said incidence face, and said light guide plate being used under a state such that a part of said emission face is covered by a reflecting-cover disposed along said first end edge,

According to a basic feature of the present invention, said emission face includes a belt-like first area extending in first range N1 from said first end edge as to correspond to said reflecting-cover and a second area extending in second range N2 as to be adjacent to said first area. Further, said second area is larger than said first area, and, emission function given to said first range is weaker than that given to said second range N2.

Said first area may be provided with a great number of first prismatic projections running in a direction generally perpendicular to said first end edge, and said second area may be provided with a great number of second prismatic projections running in a direction generally parallel to said first end edge. In this case, said first area may include a projection-height-changing area in which at least neighbourhood of boundary between said first area and said second area and projection height of said first prismatic projections in said projection-height-changing area may decrease gradually away from said first end edge so that said first prismatic projections may be connected smoothly to a base plane corresponding to roots of said second prismatic projections.

Alternatively, said first area may be formed of a flat face and said second area is formed of an emission-function face.

Next, the present invention is applied to a surface light source device comprising a light guide plate and a primary light source.

According to a feature of the present invention, said light guide plate is a light guide plate in accordance with the present invention. and said primary light source is disposed opposite to said incidence face, and said reflecting-cover is disposed along said end edge as to cover as least a part of said first area. Said reflecting-cover may be provided by an end edge of a reflecting member which is disposed as to surround said primary light source.

In addition, the present invention is applied to an image display comprising a surface light source device and a member-to-be-illuminated for image-displaying. According to a feature of the present invention, said member-to-be-illuminated is disposed as to be irradiated by illumination light outputted from said surface light source device.

With a light guide plate according to the present invention, emission intensity of a first area is smaller than that of a second area because the first area ( )first range N1) formed as corresponding to a reflecting-cove, which is provided by, for example, an end edge of a lamp reflector, has a relatively weak emission function. Accordingly, conspicuous abnormal emission is avoided from appearing even if the light guide plate is used under a condition such that a reflecting-cover is disposed as to corresponding to the first area.

In addition, under such arrangement of reflecting-cover, much of the light emitted from the first area is emitted from the second area after being returned into the light guide plate. As a result, light utilization efficiency is avoided from falling.

A surface light source device according to the present invention is capable of outputting bright and uniform illumination light due to the above merits of light guide plate. Further, an image display having a member-to-be-illuminated for displaying illuminated by the surface light source device is capable of providing an high-quality image.

### BRIEF DESCRIPTION OF DRAWINGS

FIG. 1 is an exploded perspective view of a liquid crystal display of an embodiment In addition, the present invention;

FIG. 2 is a cross section view of the liquid crystal display along line A1-A1 in FIG. 1;

FIG. 3 is an enlarged view of part B in FIG. 2;

FIG. 4 is an enlarged view of first prismatic projections as viewed from D-direction in FIG. 3;

FIG. 5a is an enlarged view of part C in FIG. 2;

FIG. 5b is a diagram illustrating troubles arising in a case where second slopes are inclined too largely;

FIG. 6 illustrates Modification 1 of the present invention in a way similar to that of FIG. 3, wherein a modified configuration of a first range of a light guide plate is shown;

FIGS. 7a and 7b are diagrams illustrating effects of the present invention, FIG. 7b being a plan view showing a state such that a fluorescent lamp and a lamp reflector have been mounted to a light guide plate employed in the present invention and FIG. 7a being a cross section view along line A2-A2 in FIG. 7b;

FIGS. 8a and 8b are diagrams illustrating a trouble state arising in a conventional light guide plate, FIG. 8b being a plan view showing a state such that a fluorescent lamp and a lamp reflector have been mounted to the conventional light guide plate and FIG. 8a being a cross section view along line A3-A3 in FIG. 7b;

FIG. 9 is an exploded perspective view of a liquid crystal display of a prior art; and,

FIG. 10 is a cross section view of the conventional liquid crystal display along line A4-A4 in FIG. 9.

### EMBODIMENT

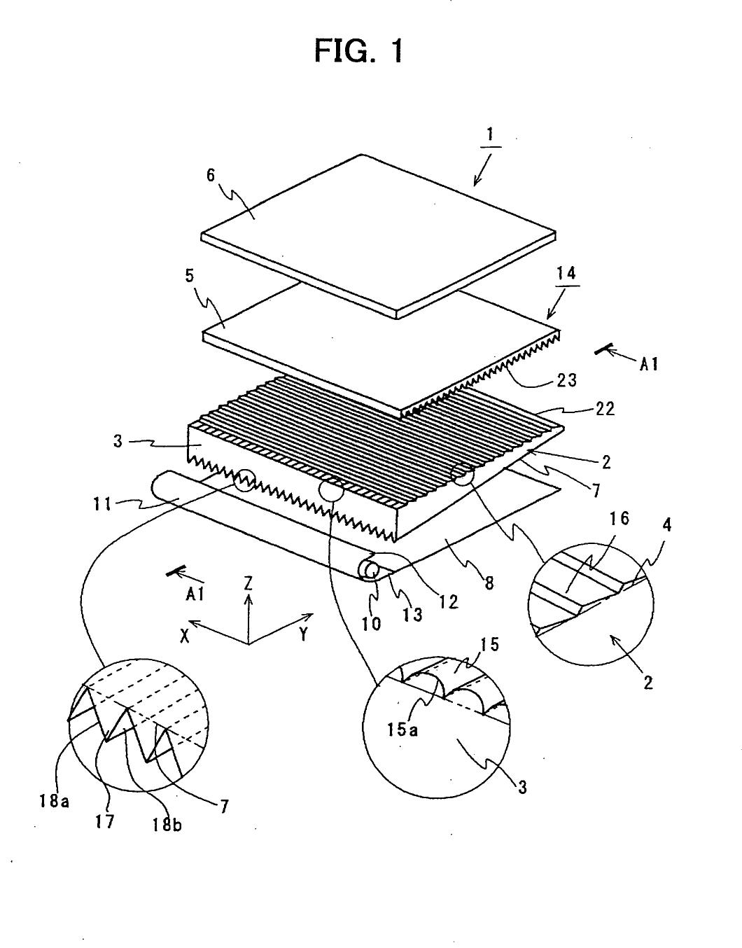

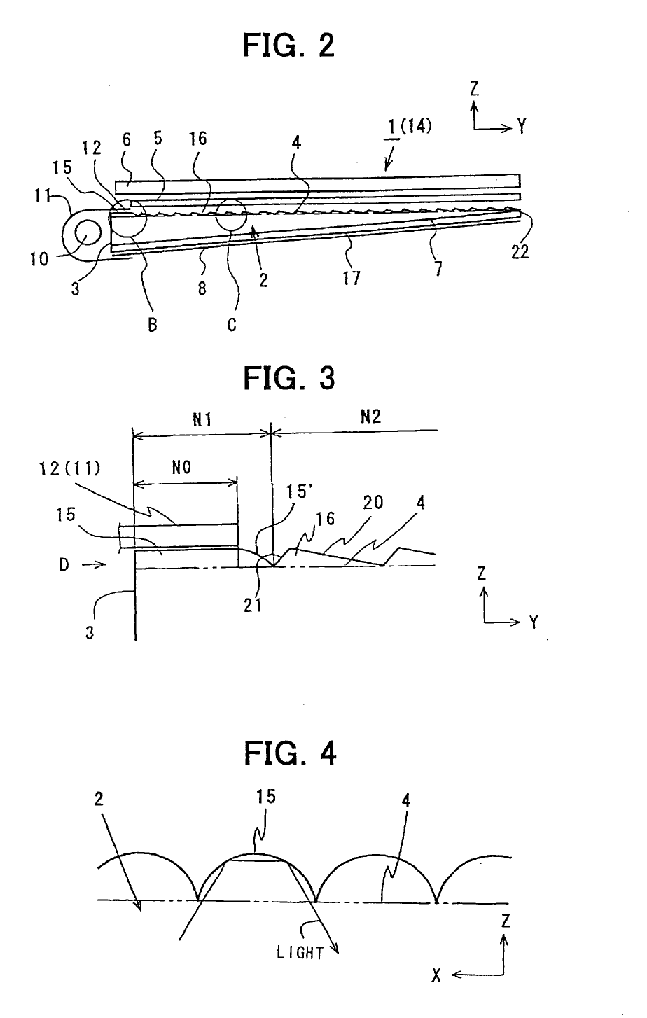

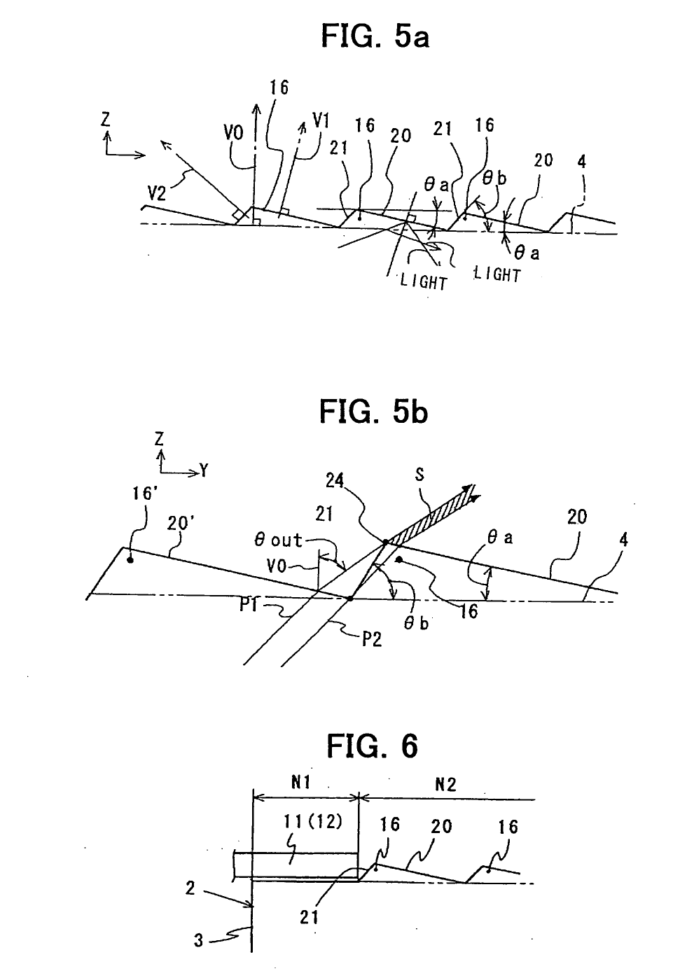

Described are embodiments and modifications thereof in accordance with the present invention. In the first place, description on the embodiment is ]developed based on FIGS. 1 to 5. FIG. 1 is an exploded perspective view of an outlined structure of liquid crystal display 1 of the embodiment, and FIG. 2 is a cross section view along line A1-A1 in FIG. 1. Further, FIG. 3 is an enlarged view of part B in FIG. 2, and FIG. 4 is an enlarged view of first prismatic projections as viewed from D-direction in FIG. 3. Still further, FIG. 5a is an enlarged view of part C in FIG. 2, and FIG. 5b is a diagram illustrating state of emission under an excessively large inclination ]angle of second slopes.

(Outlined Structure of LCD)

As shown in FIGS. 1 and 2, liquid crystal display 1 comprises surface light source device 14 and LCD-panel (an example of object-to-be-illuminated for image-displaying) disposed as to irradiated by illumination light outputted from surface light source device 14. Surface light source device 14 is provided with light guide plate 2, prism sheet 5, reflection sheet 8, rod-like fluorescent lamp (an example of primary light source) 10 and lamp reflector 11. Light guide plate 2 has emission face 4 provided by a major face, back face 7 provided by another major face opposite to emission face 4, incidence face 3 provided by a side end face (minor face) and distal end face 22 provided by another side end face (minor face) opposite to incidence face 3.

Incidence face 3 meets emission face 4 at upper end edge (end edge located at the upper side in FIG. 2=first end edge) and back face 7 at lower end edge (end edge located at the lower side in FIG. 2=second end edge). Prism sheet (an example of light control member) 5 is disposed along emission face 4 while reflection sheet 8 is disposed along back face 7. Fluorescent lamp 10 is disposed opposite to and along incidence face 3. Lamp reflector 11 is disposed as to surround fluorescent lamp 10 and has end edge portion (engaging-portion-with-emission-face) 12 which is located at the upper side in FIG. 2 and engages with emission face 4 as to cover (belt-like zone in the vicinity of incidence face 3) of emission face 4. Hereafter, this belt-like zone (a part of emission face 4) covered by end edge portion 12 is called “covering-area”.

On the other hand, the other end edge portion (engaging-portion-with-reflection-sheet) 13 of lamp reflector 11 engages with a lower face of reflection sheet 8 at neighbourhood of the lower end edge of incidence face 3. Lamp reflector 11 has a light reflective inner surface. This reflectivity may be given to lamp reflector 11 by utilizing, for example, white PET or Ag-evaporation layer. Light emitted from fluorescent lamp 10 is incident to incidence face 3 directly or after being reflected by lamp reflector 11, becoming inner-propagation-light. Inner-propagation-light undergoes various processes and is emitted from gradually from emission face 4 on the way of approaching a distal end face. The various processes are described later in detail. Light emitted from emission face 4 is redirected by prism sheet 5 and supplied to LCD-panel 6, thereby backlighting LCD-panel 6.

(Light Guide Plate)

Light guide plate 2 is made of a light permeable material such as polycarbonate (PC), polymethyl methacrylate (PMMA) or cycloolefin-type resin material. Injection molding is an employable method of manufacturing light guide plate 2. Light guide plate 2 has a generally rectangular plan shape (shape of emission face 4). Plate thickness decreases away from (along Y-direction) fluorescent lamp 10 (wedge-like cross section). Now introduced is an imaginary plane (base plane), although first and second prismatic projections (projection rows) 15 and 16 are formed on emission face 4 of light guide plate 2 overall. That is, called is “emission face” or “emission face 4”, is a flat plane which is obtained by imaginarily removing ]first and second prismatic projections 15, 16. This (imaginary) flat plane can be regarded as a reference plane for forming first and second prismatic projections 15, 16. In other words, this flat plane is “a reference plane corresponding to roots of first and second prismatic projections 15, 16. Emission face 4 is represented by this reference plane (imaginary plane is perpendicular to incidence face 3 as shown by double-dot chain line in FIGS. 1 to 5.

As mentioned previously, emission face 4 meets incidence face 3 at upper end edge (the first end edge) of incidence face 3. As shown in FIG. 1, directions of X-axis, Y-axis and Z-axis (perpendicular to each other) are defined respectively, for the sake of explanation. X-axis, Y-direction is a direction traversing incidence face 3, and Y-direction is another direction (depth-direction of light guide plate 2) perpendicular to incidence face 3. In addition, Z-direction is a still another direction perpendicular to emission face (imaginary plane=reference plane) 4. It is noted that prismatic projections 17 are formed on back face 7 overall. Thus another imaginary plane which is obtained by removing prismatic projections 17 is defined for back face 7. This imaginary plane is inclined with respect to emission face (reference plane) 4 at small angle α, being called “reference slope”. Hereafter, back face 7 is represented by this reference slope. It is noted that each of prismatic projections (projection rows) 17 formed on back face 7 runs in a direction generally perpendicular to incidence face 3. These prismatic projections 17 have a well-known light gathering function. That is, this light gathering function heightens emission directivity to directions near to a frontal direction regarding in a plane parallel to incidence face 3 (i.e. parallel to XZ-plane).

According to the most important and basic feature of light guide plate 2, emission face 4 is divided into first range (first area) N1 and second range (second area) N2. First range N1 is defined as to correspond to range NO (called “covering range N0”, hereafter) which is covered by upper end edge portion 12 of lamp reflector 11.

Upper end edge portion 12 has a light-reflective inner surface (a surface directed to emission face 4). In the shown case, covering range NO is slightly smaller than first range N1 ((See FIG. 3). In other words, first range N1 includes a narrow non-covering range”. This non-covering range is adjacent to second range N2. Second range N2 includes no covering range at all. In other words, a top of upper end edge portion 12 of lamp reflector 11 does not reach boundary between first range N1 and second range N2. First range (first area) N1 is provided with emission promotion function weaker than that with which second range (second area) N2 is provided. This avoids first range (first area) N1 from providing strong emission. On the other hand, emission occurs without spoiling directivity in second range (second area) N2. The reason why first range N1 is defined as to include a very narrow non-covering range is that upper end edge portion 12 of lamp reflector 11 is to be avoided surely from invade second range N2. Such invasion would cause the inner surface of upper end edge portion 12 to reflect strong emission from second range N2 and return the light into light guide plate 2, resulting in ABNORMAL EMISSION (appearing of bright portion R) due to mechanism described previously. Existence of non-covering range as above upper end edge portion 12 can not reach second range N2 even if some assembling errors are expected, with the result that abnormal emission is avoided, Accordingly, it is preferable to determine dimension (A N=dimension of N1−dimension of N0) is defined under consideration of the maximum assembling errors expected. A practical value of ΔN falls in a range, for example, roughly from 0.1 mm to 0.5 mm.

In the embodiment, a great number of first prismatic projections 15 are formed in first range N1 and a great number of second prismatic projections 16 are formed in second range N2. Prismatic projections 15 run generally in Y-direction and prismatic projections 16 run generally in X-direction. Prismatic projections 16 have a constant projection-height. On the other hand, projection-height of respective prismatic projections 15 falls gradually in the non-covering range (See reference numeral 15′) and is equal to 0 at the boundary between first range N1 and second range N2, although projection-height is constant in covering range NO, as shown in FIG. 3. Accordingly, prismatic projections 15 are connected to the forementioned reference plane (the imaginary plane representing emission face 4) at the boundary,

Each of prismatic projections 15 has a arc-like cross section projected upward, as shown in FIGS. 1 and 4. On the other hand, each of prismatic projections 16 has a triangle-like cross section projected upward, as shown in FIGS. 1, 6 and 5. Further, each of prismatic projections 15 has a pair of first slope 20 and second slope 21. First slope 20 is a gentle slope inclined at angle θ a with respect to reference plane, Second slope 21 is a steep slope inclined. inversely as compared with first slope 20, at angle θ b with respect to reference plane, In other words, first slope 20 is a descending slope and second slope 21 is an ascending slope as viewed from incidence face 3.

In FIG. 5, V0 gives a normal direction with respect to reference plane (the imaginary plane representing emission face 4) and V1 gives a normal direction with respect to first slope 20. In addition, V2 gives a normal direction with respect to second slope 21. A ridge-line at which both slopes meet each other runs generally in X-direction. Interval of ridge-lines adjacent to each other (i.e. arranging pitch of projection rows 16) is constant.

in incidence angle of inner propagation light on being incident to first slope 20 is smaller by 2 θ as compared with cases where no projection row 16 is formed. As a result, incidence at incidence angles not greater than critical angle occurs easily, thereby making escape (emission) from light guide plate 2 easy, On the other hand, light hardly escapes (outgoes) from second slope 21. However, as a whole, emission is promoted by projection rows 15 as compared with cases where no projection 15 is formed because second slope 16 is narrower than first slope 20. Thus first slopes 20 intensively urges inner propagation light to be emitted from light guide plate 2 on the way of approaching distal end face 22, Accordingly, second range N2 has emission promotion function as a whole. To the contrary, first range N1 does not have such emission promotion function.

Although prismatic projections 15 are formed in first range N1, emission promotion like that due to first slopes 20 of prismatic projections 16 is not realized because prismatic projections 15 run generally in a direction perpendicular to incidence face 3, It is noted that emission occurs slightly in first range N1.

As mentioned previously, much of weak-intensity emission in first range N1 is reflected by upper end edge portion 12 of lamp reflector 11 to be returned into light guide plate 2, then being emitted after coming to second range N2.

Angle θ a greater than 20 is not practical although the greater θ a is the stronger is emission promotion function in general. Angle θ a is allowed to be not constant in second range N2 overall, and a preferable variation of angle ranges from 0 degree to 20 depending on distance from incidence face 3. A more preferable changing range is from 0 degree to 10 degrees and a still more preferable changing range is from 0.5 degrees to 5 degrees.

In general, it is preferable to choose a suitable range under consideration of size of light guide plate 2 (distance from incidence face 3 to distal end face 22 (light guiding distance)), plate thickness at incidence face 3, plate thickness at distal end face 22, emission characteristics and others for determining the optimum values of θ a.

On the other hand, second slopes 21 are preferably formed as to have values of θ b so that light guided from incidence face 3 to distal end face 22 is difficult to be incident to slopes 21 as possible.

In addition, it is preferable to determine θ b as to prevent second slopes 21 from bringing a dark ]area (hatched portion) S by taking account of relation between inner propagation light and emission from first slopes 20′ adjacent to each other in the vicinity of incidence face 3, as illustrated in FIG. 5b.

For example, under such that refractive index n of light guide plate 2 is 1.49, θ a is 1 degree and θ out (direction of the strongest emission from first slope 20 (main emission direction)) is 70 degrees, a preferable value of θ b is about 50 degrees.

Inner propagation light of such structured light guide plate 2 proceeds to second range N2 after undergoing not remarkable emission promotion of slopes 15a provided by first prismatic projections 15, Then in second range N2, repeated inner reflections occur at first slopes 20 of second prismatic projections 16 and slopes 18a, 18b of prismatic projections 17 on back face 7 on the way of approaching distal end face 22. Emission is intensively promoted in such processes in second range N2 as described above without disturbance of directivity. It is noted that some inner propagation light is reflected by distal end face 22 or reflected by a frame or the like not shown and returned into light guide plate 2 after being emitted through distal end face 22. A part of such returning light is inner-incident to second slopes 21 on the way of approaching incidence face 3. On this inner-incidence, light component having incidence angles smaller than critical angle is emitted from light guide plate 2 through second slopes 21. Much of such light has directivity which is given through light-gathering effected by prismatic projections 17 on back face 7.

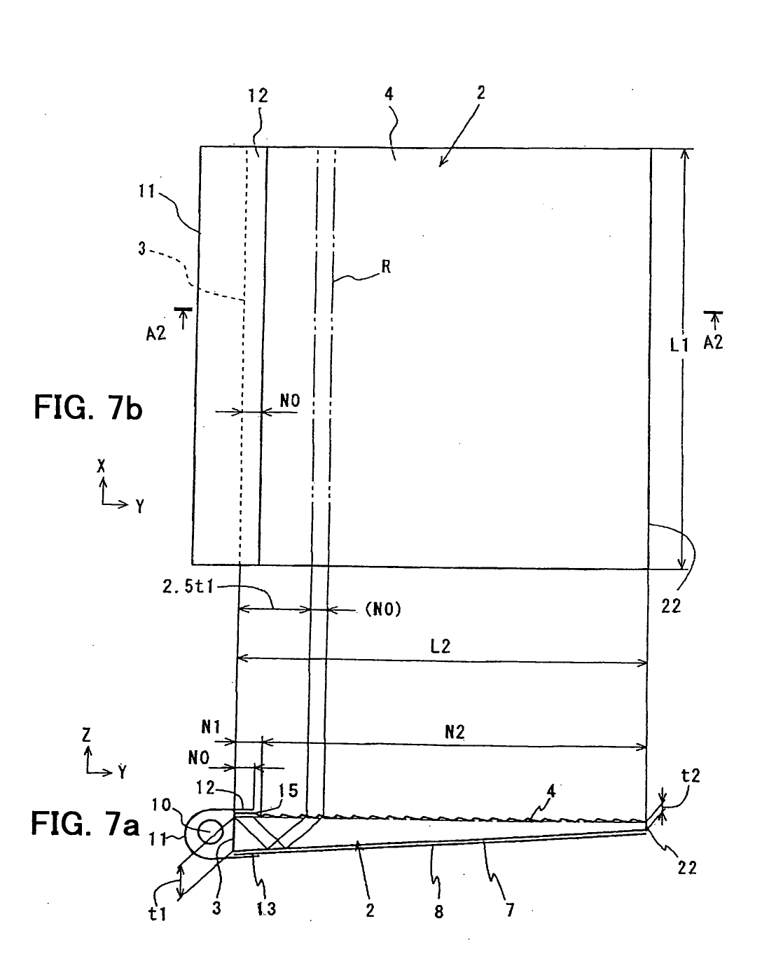

FIGS. 7a and 7b shows concrete dimensions for light guide plate 2. Respective values of dimensions are as follows.
L1 of emission face=250 mm
L2 of emission face=190 mm
Plate thickness t1 of light guide plate (incidence face)=2.0 mm
Plate thickness t2 of light guide plate (distal end face)=0.7 mm
Y-direction dimension of first range N1=1 mm˜2 mm

(Light Control Member)

Prism sheet 5 shown inn FIG. 1 or 2 is a well-known light control member, being made of a light permeable plastic material (such as PET, PMMA or PC). Planar shape and dimension of prism sheet 5 are generally the same as those of light guide plate 2. Prism sheet 5 has an inner face (a face directed to emission face 4) provided with a great number prismatic projections 23 running in a direction generally parallel with incidence face 3. Each of prismatic projections has a triangle-like cross section. As known well, prism sheet 5 gathers light emitted from emission face 4 to directions near to a frontal direction regarding in a plane parallel with incidence face 3 (XZ-plane).

(Reflection Sheet)

Reflection sheet 8 shown in FIGS. 1 and 2 is a well-known optical member, which has a highly reflective inner surface (a surface directed to back face 7 of light guide plate 2). Reflectivity is given by, for example, white pigment, reflective PET sheet or aluminum. Plan shape and dimension of reflection sheet 8 are generally the same as those of generally rectangular back face 7 of light guide plate 2. Reflection sheet 8 reflects and returns light, which has leaked through back face 7, into light guide plate 2 through a well-known reflection function. As a result, loss of light is prevented.

### Effects ]of the Embodiment

Light guide plate 2 as described above gives a lower emission intensity in first range N1 which is covered generally overall by upper end edge portion 12 of lamp reflector 11 as compared with emission intensity in second range N2. Accordingly, quantity of light reflected by upper end edge portion 12 and returned into light guide plate 2 is small. As a result, abnormal emission is avoided. As shown in FIG. 7, BRIGHT PORTION R, which would appear due to light reflected by upper end edge portion 12 and returned into light guide plate, is prevented from appearing thereby enabling illumination light emitted to be bright and uniform.

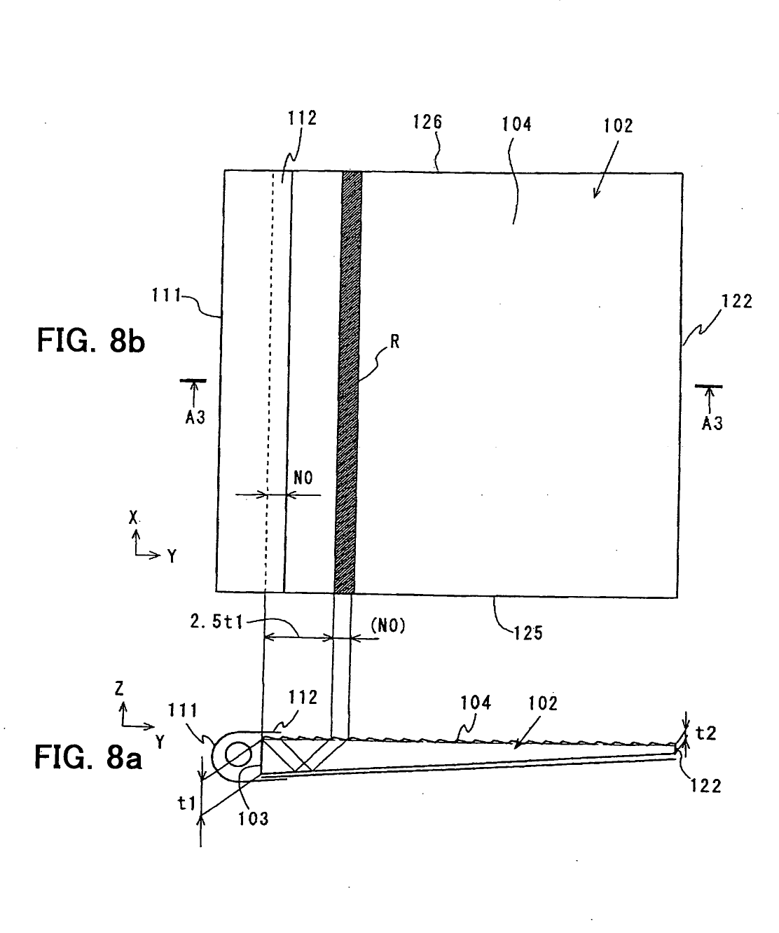

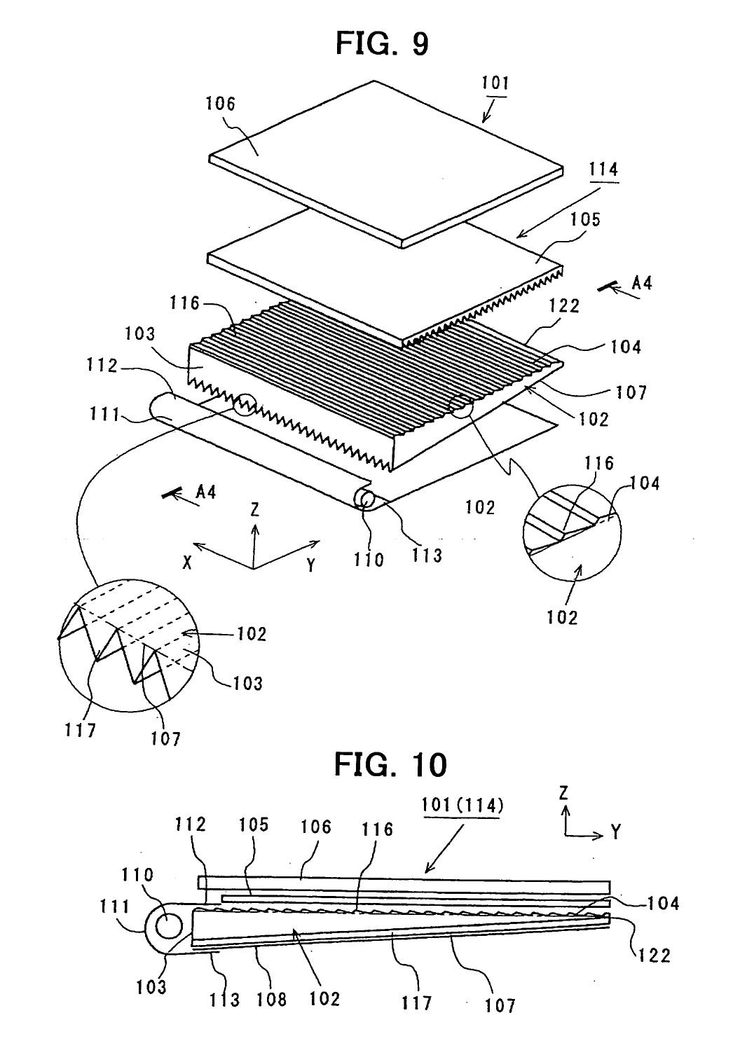

To the contrary, with the prior art shown ]in FIGS. 9, 10, bright portion (a hatched belt-like portion in FIG. 8b) R appears as shown in FIGS. 8a, 8b, wherein bright portion R is located at a position of about 2.5×t1 on emission face 4 and has width NO generally equal to THAT OF upper end edge portion 112 of lamp reflector 111. In general, belt-like portion R appears as to extend in parallel with incidence face 103 from one side face 125 to another side face opposite to side face 125. It is noted that t1 is thickeners of light guide plate 102 at incidence face 103. According to the embodiment, as illustrated in FIG. 7, emission face 4 shows no bright portion R which wold appear at a certain position (2.5×t1) as shown in FIGS. 8a, 8b. It is noted that t1 is thickness of light guide plate 2 at incidence face 3.

Further, emission from second range N2 can be promoted by second prismatic projections 16 without disturbance of directivity.

In addition, surface light source device 14 employing light guide plate 2 as above can supply high-quality illumination light to liquid crystal display panel 6. As a result, liquid crystal display 1 provides high-quality displaying.

### Modification 1

FIG. 6 illustrates Modification 1 of light guide plate 2 in accordance with the present invention. Light guide plate 2 shown in FIG. 6 has first range N1 which is defined as a range (a part of emission face 4) covered by upper end edge portion 12 of lamp reflector 11. Namely, first range N1 includes substantially no non-covering range. In other words, covering range NO, which is a range covered by upper end edge portion 12 of lamp reflector 11, is just the same as first range N1 in this modification. First range N1 is a flat face without being provided with prismatic projections 15. On the other hand, second range (another part of emission face 4) N2 is provided with numerous prismatic projections 16 in generally same way as the above-described embodiment. In the case of this modification, emission function of first range N1 is lower than that of second range N2, too. Accordingly, emission from first range N1 is relatively weak. As a result, abnormal emission is avoided due to reason generally the same that in the case of the above-described embodiment.

### Other Modifications

The above-described embodiment and modification do not limit the scope of the present invention. Fr example, the following various modifications are allowed.

(i) Second range N2 of emission face 4 of light guide plate 2 may be provided with different emission promotion means instead of, or in addition to second prismatic projections 16.

Examples of such different emission promotion means are polygonous-pyramid-like projections or fine uneven surface which are capable of promoting emission without spoiling directivity.

8ii) First range N1 can be provided with different surface configuration so far as emission function can be reduced as compared with that of second range N2. For example, the same emission promotion means employed for second range N2 may be applied to first range N1 at a lower density.

(iii) Prismatic projections on back face 7 may be omitted.

(iv) Each first prismatic projection 15 may have a different cross section shape. For example, arc-like valley portions may be employed in in addition to arc-like top portions. Alternatively, arc-like configuration may employed for only valley parts, or instead, simple triangle-like cross section may be employed.

(v) Surface of second prismatic projections 16 may be roughened (fine uneven surface formed by, for example, sand blasting), as required, for prevent second light guide plate 5 from sticking to the surface at a degree such that directivity of light is not spoiled.

[symbol]

(vi) For second prismatic projections 16 formed in second range N2, one or more of factors (such as pitch dimension of top portions of projections 16, projection-height, inclinations angles of first slopes 20 or second slopes 21) may be changed depending on distance from incidence face 3 under consideration of demanded emission characteristics or the like.

(vii) In cases like the above embodiment and modification where emission with strong directivity is provide, inner-incidence angles are apt to be larger than critical angle, in second range N2, in the vicinity of incidence face 3. Therefore, at least in the vicinity of incidence face 3, second range N2 is preferably provided with emission promotion means capable of promoting emission intensively.

However, the range other than the part of the nearer side of second range N2 may have no second prismatic projection 16.

(viii) reflectivity of an inner surface of upper end edge portion 12 (emission-face-engaging-portion) of lamp reflector 11 may be adjusted as required. The inner surface is provided with some light shadowing function of giving black or grey so far as a large reduction of light utilization efficiency is not caused. In this case, abnormal emission is avoided more surely.

(ix) Prismatic projections 23 of prism sheet 5 may be formed upward (on a face directed to LCD-panel 6).

Two prism sheets may be disposed ss too be piled so that running directions of prismatic projections are vertical and the projections are directed upward between light guide plate 2 and LC/panel 6.

(x) Point-like light sources SUCH AS LED may be employed as primary light source, For example, a plurality of LEDs arranged at a suitable interval may be employed instead of fluorescent lamp 10.

(xi) Although in the cases of the above embodiment and modification, reflecting-cover-portion is provided by upper end edge portion 12 of lamp reflector 11, reflecting-cover-portion may be provided by other member or a part thereof. For example, substrate of frame, if they have reflection function, may be disposed instead of upper end edge portion 12 of lamp reflector 11.

(xii) At both corner portions, near to incidence face 3, of back face 7 or emission face 4 of light guide plate 2, rough ]surfaces irregularly reflecting light may be formed in order that non-emission end parts of fluorescent lamp 10 brings dark portions.

(xiii) Although lamp reflector 11 U-like opening toward Y-direction as shown in FIG. 2, other shapes may be employed. For example, shapes modified as to match shapes of frames accommodating surface light source device 14, or the like.

(xiv) Liquid crystal display panels FOR DISPLAYING other than LCD-panel 6 may be illuminated by surface light source device 14. fURTHER, surface light source device 14 may be applied to liquid crystal display panels such as guidance-panels, character plates, advertising panels.

What is claimed is:

1. A light guide plate comprising:
an emission face provided by a major face;
a back face provided by another major face located oppositely;
an incidence face provided by a side end face, said incidence face meeting said emission face at a first end edge of said incidence face and meeting said back face at a second end edge of said incidence face, and said light guide plate being used under a state such that a part of said emission face is covered by a reflecting-cover disposed along said first end edge, wherein
said emission face includes a belt-like first area extending in first range N1 from said first end edge as to correspond to said reflecting-cover and a second area extending in second range N2 as to be adjacent to said first area;
said second area is larger than said first area; and,
emission function given to said first range is weaker than that given to said second range N2.

2. A light guide plate according to claim 1, wherein said first area is provided with a great number of first prismatic projections running in a direction generally perpendicular to said first end edge;
said second area is provided with a great number of second prismatic projections running in a direction generally parallel to said first end edge;
said first area includes a projection-height-changing area in which at least neighbourhood of boundary between said first area and said second area; and,
projection height of said first prismatic projections in said projection-height-changing area decreases gradually away from said first end edge so that said first prismatic projections are connected smoothly to a base plane corresponding to roots of said second prismatic projections.

3. A light guide plate according to claim 1, wherein said first area is formed of a flat face and said second area is formed of an emission-function face.

4. A surface light source device comprising:
a light guide plate; and
a primary light source, wherein
said light guide plate is in accordance with claim 1, 2 or 3;
said primary light source is disposed opposite to said incidence face; and
said reflecting-cover is disposed along said end edge as to cover as least a part of said first area.

5. A surface light source device in accordance with claim 4, wherein said reflecting-cover is provided by an end edge of a reflecting member which is disposed as to surround said primary light source.

6. An image display comprising:
a surface light source device; and
a member-to-be-illuminated for image-displaying, wherein said member to-be-illuminated is disposed as to be irradiated by illumination light outputted from said surface light source device; and,
said surface light source device is in accordance with claim 4.

7. An image display comprising:
a surface light source device;
a member-to-be-illuminated for image-displaying, wherein said member-to-be-illuminated is disposed as to be irradiated by illumination light outputted from said surface light source device; and,
said surface light source device is in accordance with claim 5.
